(19) United States
(12) Patent Application Publication
(10) Pub. No.: US 2012/0234953 A1
(43) Pub. Date: Sep. 20, 2012

(54) COUPLING SYSTEM BETWEEN TOOL HOLDERS AND MACHINE TOOLS FOR CRUSHING MACHINES

(76) Inventor: Mirco Risi, San Giovanni In Persiceto (IT)

(21) Appl. No.: 13/498,152

(22) PCT Filed: Sep. 28, 2010
(86) PCT No.: PCT/EP2010/005911

§ 371 Date: Jun. 1, 2012

(30) Foreign Application Priority Data
Sep. 29, 2009 (IT) BO2009A000624

(51) Int. Cl. B02C 23/00

(52) U.S. Cl. 241/285.1

(57) ABSTRACT

Coupling system between tool holders and machine tools for crushing machines, wherein the tool (1) comprises a cavity (5) with a protrusion (6) having circular profile with radius R and centre C adapted to be concentrically coupled with a suitable semicircular recess (16) having the same radius R′ on the tool holder (2), said coupling being stabilized by at least one safety element (4), such as, for example, a safety pin placed into suitable through holes formed in the tool and in the tool holder and by a tool protrusion (10) penetrating into a tool holder recess (13), said tool holder recess (13) being opposite to said semicircular recess (16).

### FIELD OF THE INVENTION

The present invention relates to the field of machines and equipments for crushing minerals, stone materials, stones, hard construction materials, metal materials and similar materials. In particular, the present invention relates to a coupling system between tool holders and machine tools.

### STATE OF THE ART

Several systems are known in the art for coupling machine tools to the corresponding tool holders in crushing machines or equipments, both for stationary plants and for buckets attached to movable machines.

In the known prior art systems, the tools exhibit wearing problems in the radial, frontal and lateral directions. Moreover, the systems are characterized by the instability of the coupling between the tools and the tool holders. Furthermore, the tool holders are generally insufficiently protected by the tools so that the wearing of the tool holders can not be prevented.

A further problem concerning the known coupling systems relates to the complexity of the procedures required to assemble the tool to the tool holder.

An example of a crushing equipment can be found for instance in DE 1 274 423. The system described therein comprises an arm, a head which is interlocked with the arm and a locking block. In particular, the arm comprises a circular recess and the head comprises a cavity with a circular protrusion matching the shape of the circular recess. The arm is inserted into the cavity of the head and coupled therein by means of the recess and the protrusion. In order to lock the arm to the head, the system comprises a locking block which is kept in the locking position by means of a flat spring which is fixed to the arm by means of a screw.

The assembly and disassembly procedures of the system according to DE 1 274 423 are accordingly elaborate and time consuming. Moreover, the flat spring does not guarantee a safe coupling between the arm and the head. Furthermore, the structure of the system and, in particular, the square-edge corners formed in proximity of the locking block, does not allow the inhibition of the wearing of the arm.

A further example of an equipment for a beater mill can be found in DE 1 163 641. In the system described in DE 1 163 641 the head is provided with a cavity which is opened both at the side and at the bottom of the head itself so that the arm can be inserted into the cavity of the head by sliding it inside the cavity. Securing the arm inside the cavity is therefore complex and unreliable. Moreover, the wearing of the system can not be effectively prevented. In particular, the arm may undergo severe damaging and even break in particular because of the square-edge corners formed at the junction between the arm and the head of the system.

A further example of a replaceable tip member for a two-part hammer can be found in U.S. Pat. No. 3,367,585. The system described in U.S. Pat. No. 3,367,585 comprises a shank member and a head secured to the shank by a pin welded in place by a weld. The shank has a pair of opposed and parallel side walls extending downwardly to inclined shoulder walls. Below the shoulder walls, the shank has a connecting portion with a rounded pocket adjacent to a rounded projection. The tip comprises a hook adjacent to a recess. The hook of the tip is adapted to be coupled to the rounded pocket of the shank and the recess of the tip is adapted to be coupled to the rounded projection. In order to assemble the tip to the shank, the upper walls of the tip slide along the inclined walls shoulder of the shank to an end position wherein the hook and the recess are coupled to the pocket and to the projection, respectively. The system according to U.S. Pat. No. 3,367,585 can undergo strong wearing processes. In particular, the parallel side walls of the shank are subject to lateral wearing processes. Moreover, the coupling between the tip and the shank is unstable because it is secured by the adjacent hook and recess only at one side of the tip so that the tip and the shank can be accidentally uncoupled during the crushing processes.

The present invention allows overcoming the problems and drawbacks of the systems known in the prior art. In particular, the present invention guarantees and easy but nevertheless stable and safe coupling between the tool and the tool holder. The assembling and disassembling processes of the system according to the present invention can be easily and quickly carried out. The coupling between tool and tool holder is efficient and stable.

### SUMMARY

The present invention relates to a coupling system between tool holders and machine tools for crushing machines.

In the system according to an embodiment of the present invention, the tool comprises a cavity with a protrusion having circular profile with radius R and centre C adapted to be concentrically coupled with a suitable semicircular recess having the same radius R′ on the tool holder, said coupling being stabilized by at least one safety element and by a tool protrusion penetrating into a tool holder recess, said tool holder recess being opposite to said semicircular recess.

In the system according to a further embodiment of the present invention, the tool comprises two outer side surfaces, an upper surface and a front crushing surface, said surfaces being wide and resistant to the wearing during the crushing processes and adapted to protect the tool holder.

In the system according to a further embodiment of the present invention, the coupling between the tool and the tool holder is safely kept in place by means of the geometrical configuration of the inner cavity of the tool, said configuration being congruent with the external profile of the tool holder, even during the inversion of the working direction of the tool holder without weighing on the safety element.

According to a further embodiment of the present invention, the tool protrusion is defined by a second side portion of said cavity, said second side portion being opposite to said protrusion having circular profile, and by an upper outer surface of said tool.

According to a further embodiment of the present invention, the tool holder comprises a tool holder protrusion, said semicircular recess being at a first side of said tool holder protrusion, said tool holder further comprising a tool holder recess, said tool holder recess being placed at a second side of said tool holder protrusion opposite to said first side, said tool holder recess being adapted to house at least the apex of said tool protrusion.

According to a further embodiment of the present invention, the second side of said tool holder protrusion comprises a curved surface, and the side surface of said tool holder recess is formed as an extension of said curved surface.

According to a further embodiment of the present invention, the curved surface of said tool holder protrusion is adapted to fit together with a second side portion of said cavity of said tool, said second side portion being opposite to said protrusion having circular profile.

According to a further embodiment of the present invention, the tool holder protrusion comprises an apex portion adapted to abut the bottom portion of said cavity of said tool.

According to a further embodiment of the present invention, the safety element is placed into a through hole formed by the alignment of a first through hole drilled in the side surfaces of said tool in correspondence to said cavity with a second through hole drilled into said tool holder.

According to a further embodiment of the present invention, the tool holder comprises a main external curved surface so that the cross section of said tool holder in a plane substantially perpendicular to the rotation axis of said tool holder has substantially the shape of a portion of a spiral, and wherein said tool comprises an upper surface, said upper surface of said tool substantially forming an extension of said main external curved surface of said tool holder when said tool and said tool holder are coupled.

### BRIEF DESCRIPTION OF THE DRAWINGS

The present invention will be described with reference to the enclosed drawings wherein the same reference numbers refer to the same and/or similar parts of the system. In the drawings:

FIG. 1 schematically displays the cross section at mid length of a crushing tool according to an embodiment of the present invention;

FIG. 2 schematically displays the cross section at mid length of a tool holder adapted to be coupled with the tool shown in FIG. 1 according to an embodiment of the present invention;

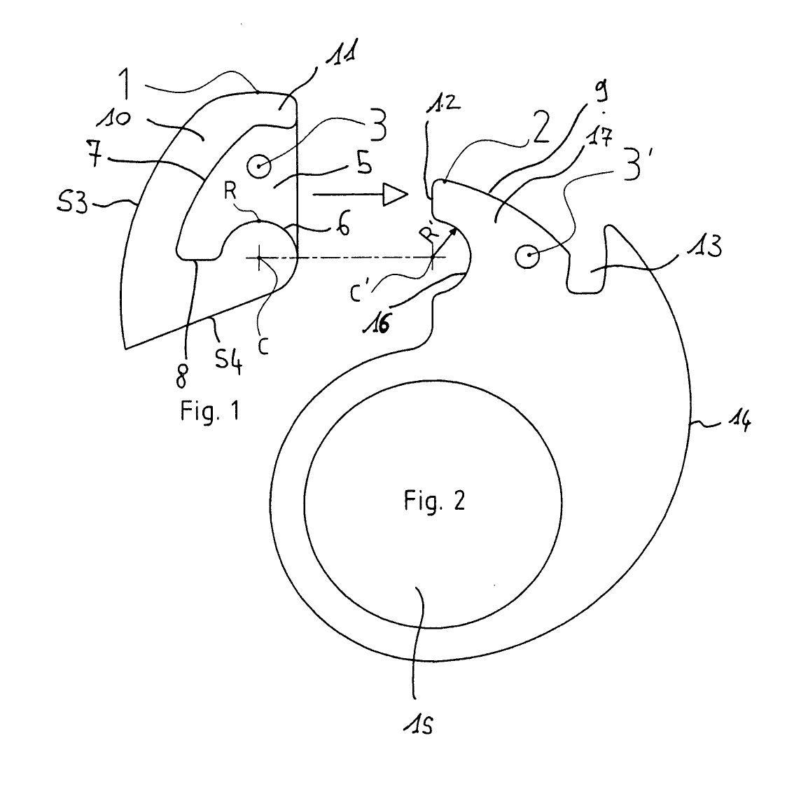

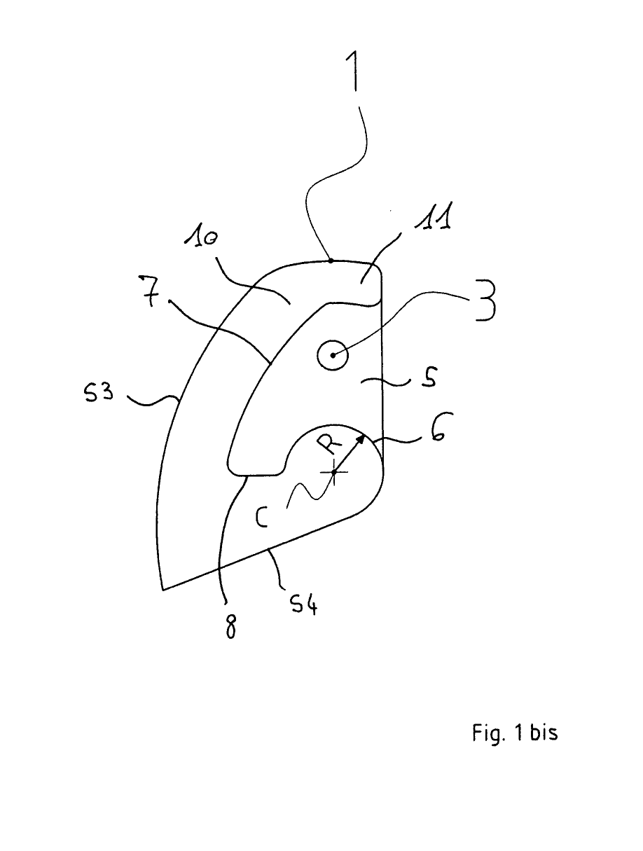

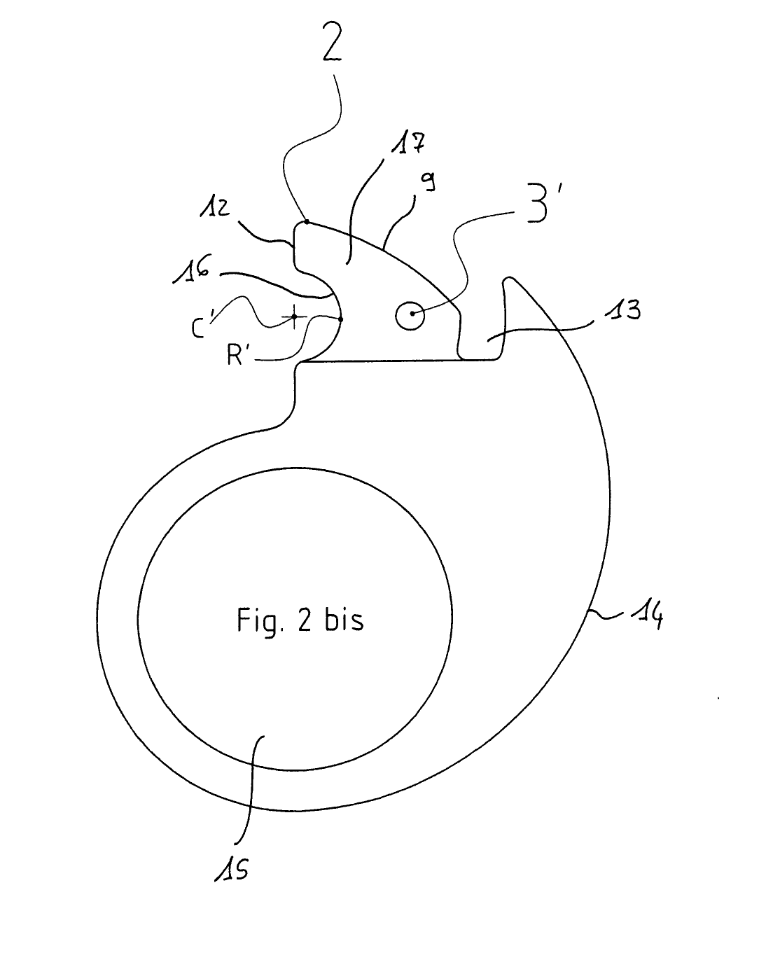

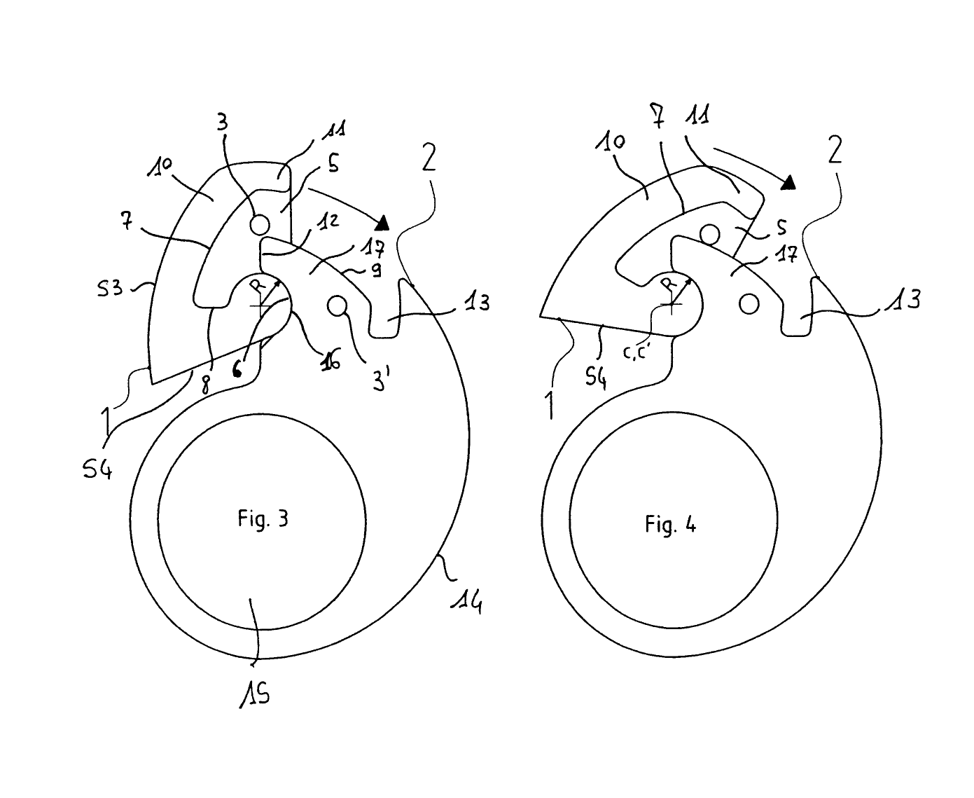

FIG. 1bis displays an enlargement of FIG. 1;

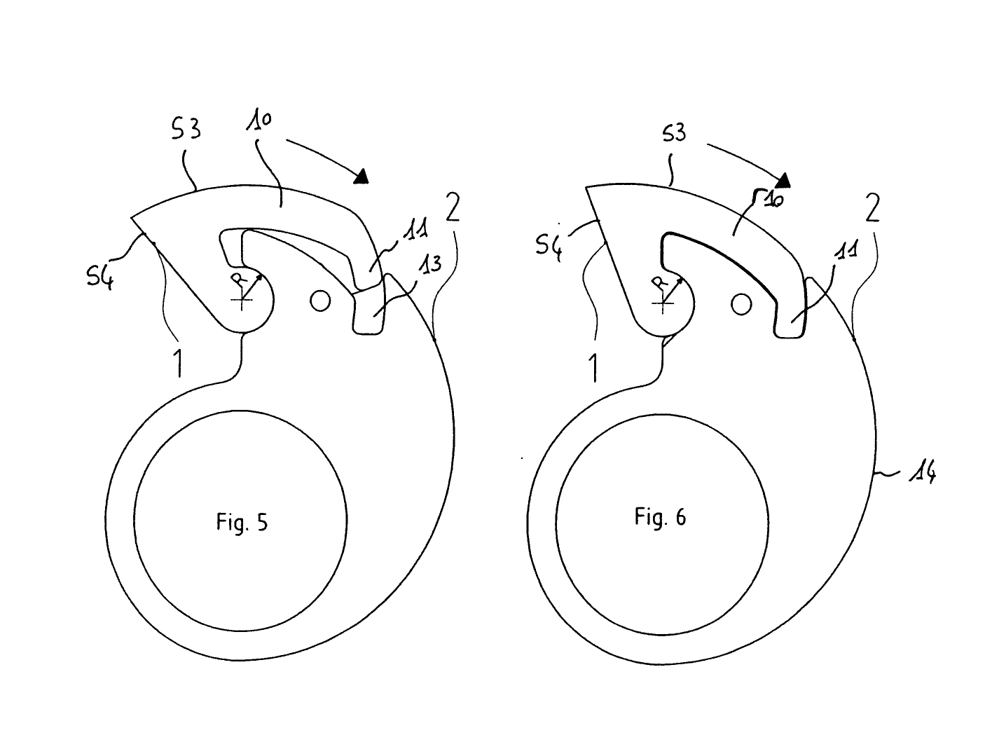

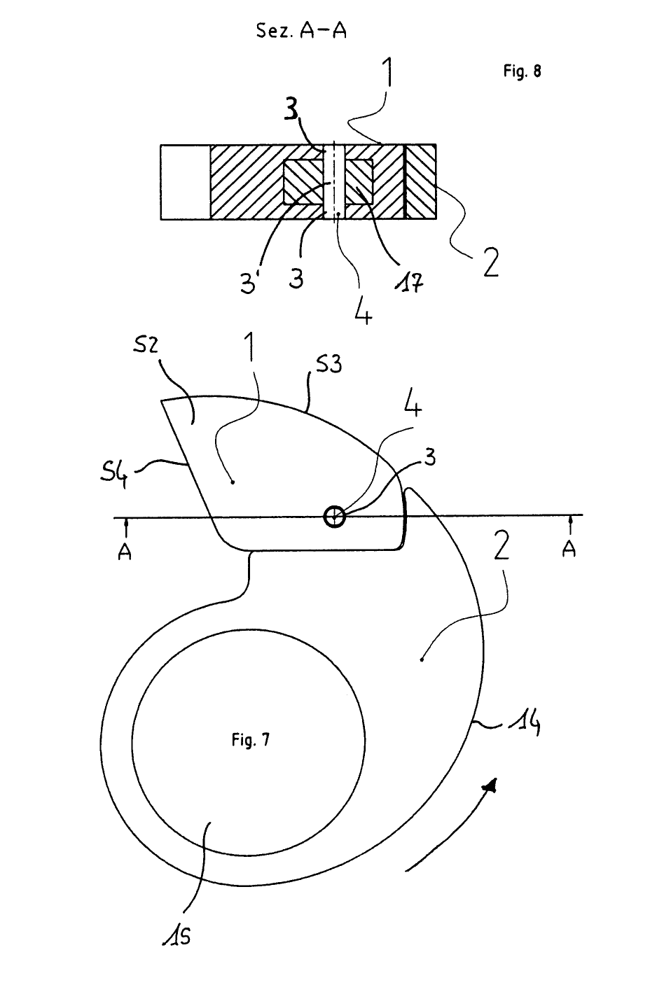

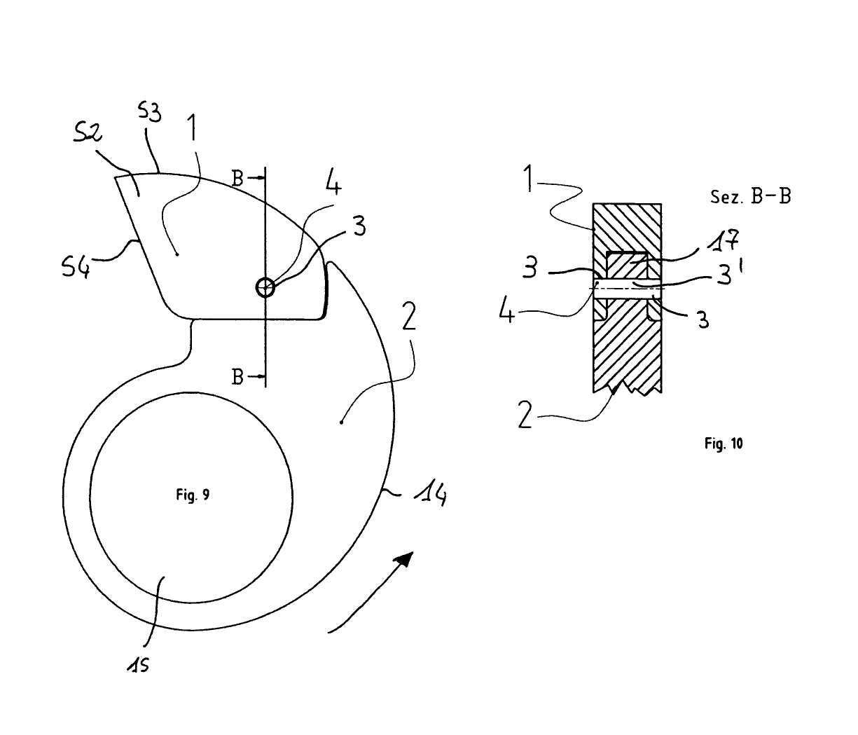

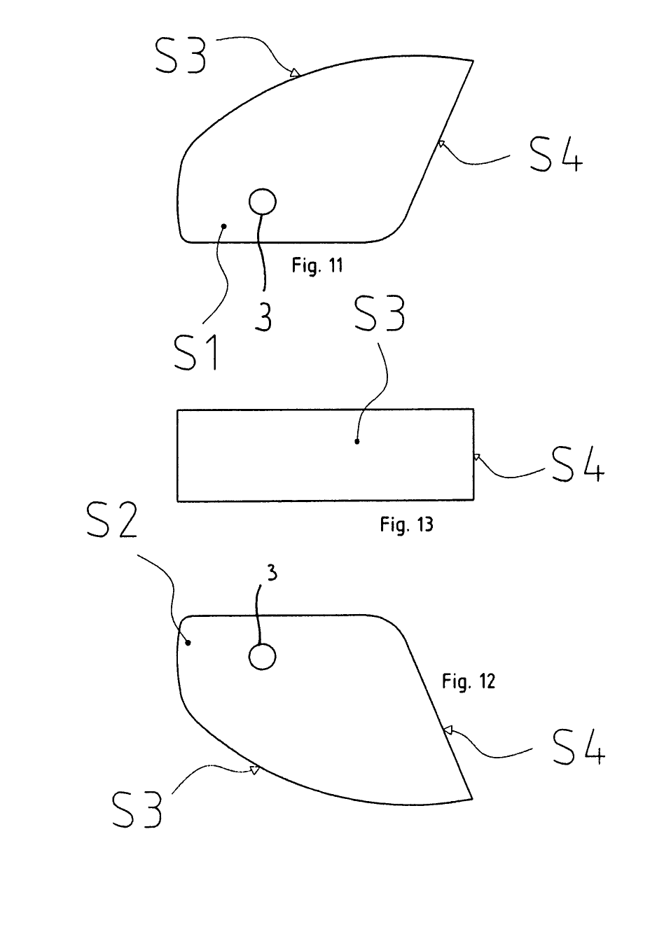

FIG. 2bis displays an enlargement of FIG. 2;

FIGS. 3 to 6 schematically display four phases of the coupling process between the tool shown in FIG. 1 and the tool holder shown in FIG. 2. The cross sections at mid length of the tool and of the tool holder are shown;

FIG. 7 schematically displays a side view of a tool coupled to a tool holder according to an embodiment of the present invention;

FIG. 8 schematically displays the horizontal cross section of the system along the line A-A shown in FIG. 7;

FIG. 9 schematically displays a side view of a tool coupled to a tool holder according to an embodiment of the present invention;

FIG. 10 schematically displays the vertical cross section of the system along the line B-B shown in FIG. 9;

FIGS. 11 to 13 schematically display the outer surfaces of the tool according to an embodiment of the present invention: in particular, FIG. 11 schematically displays a first side surface of the tool,

FIG. 12 schematically displays the upper surface of the tool,

FIG. 13 schematically displays a second side surface of the tool opposed to the first side surface shown in FIG. 11.

### DETAILED DESCRIPTION

In the following, the present invention is described with reference to particular embodiments as shown in the enclosed drawings. Nevertheless, the present invention is not limited to the particular embodiments described in the following detailed description and shown in the figures, but, instead, the embodiments described simply exemplify several aspects of the present invention, the scope of which is defined by the appended claims.

Further modifications and variations of the present invention will be clear for the person skilled in the art. Therefore, the present description has to be considered as including all the modifications and/or variations of the present invention, the scope of which is defined by the appended claims.

As can be seen in FIGS. 1 and 1 bis, the crushing tool 1 exhibits an internal cavity 5. The cavity 5 is structured so as to fit together with a corresponding protrusion 17 of the tool holder 2 shown in FIGS. 2 and 2bis.

In particular, the cavity 5 comprises a circular side portion 6 having curvature radius R and centre C. The side portion 7 of the cavity 5 opposite to the circular side portion 6 is curved so as to fit together with the curvature of the side surface 9 of the protrusion 17 of the tool holder 2. The circular side portion 6 and the opposite side portion 7 of the cavity 5 are connected by means of the bottom portion 8 of the cavity 5. The circular side portion 6 of the cavity 5 is formed as an extension of the frontal crushing surface S4 of the tool 1. The side portion 7 of the cavity runs substantially parallel to the upper surface S3 of the tool 1. In particular, as can be seen in FIGS. 1 and 1 bis, the side portion 7 of the cavity 5 and the upper surface S3 of the tool 1 define a hook-like protrusion 10 in the mid-length cross section of the tool 1. The hook-like protrusion 10 has an apex portion 11.

As can be seen in FIGS. 2 and 2bis, the tool holder 2 comprises a protrusion 17 shaped so as to fit together with the cavity 5 of the tool 1. In particular, the protrusion 17 is adapted to be inserted into the cavity 5 of the tool 1 and to be engaged therein. The protrusion 17 comprises a semicircular recess 16 having radius of curvature R′ and centre C′. In particular, the semicircular recess 16 is located at a first side of the protrusion 17. The semicircular recess 16 is adapted to fit together with the circular side portion 6 of the cavity 5 of the tool 1. The radius of curvature R′ of the circular recess 6 corresponds to the radius of curvature R of the circular side portion 6 of the cavity 5. The second side of the protrusion 17 opposite to the first side comprising the semicircular recess 16 comprises a curved side surface 9. The curved side surface 9 is adapted to fit together with the side portion 7 of the cavity 5 of the tool 1. The first side and the second side of the protrusion 17 are connected by means of an apex portion 12 which is adapted to abut the bottom portion 8 of the cavity 5 of the tool 1.

The tool holder 2 further comprises a recess 13 adapted to house the apex portion 11 of the hook-like protrusion 10 of the tool 1. The recess 13 is located opposite to the semicircular recess 16. In particular the side surface of the recess 13 is formed as an extension of the curved surface 9 of the second side of the protrusion 17.

The tool holder 2 comprises a main external curved surface 14 and a main cylindrical opening 15. The main cylindrical opening 15 is adapted to secure the tool holder 2 to a shaft of the crushing machine so as to allow the tool holder 2 to rotate. In the schematic configuration shown in FIGS. 2 and 2bis, the system rotates in the counterclockwise direction in order to perform the crushing action. In particular, when the tool 1 is coupled to the tool holder 2 and the system rotates in the counterclockwise direction, the frontal crushing surface S4 of the tool collides against the material to be crushed.

Moreover, as can be seen in FIG. 2bis, the main external curved surface 14 of the tool holder is such that the cross section at mid length of the tool holder 2 in the plane of the figure, i.e. in a plane substantially perpendicular to the rotation axis of the tool holder 2, has substantially the shape of a portion of a spiral.

FIGS. 3 to 6 schematically display four phases of the coupling process between the tool 1 and the tool holder 2. The cross sections at mid length of the tool 1 and of the tool holder 2 are shown.

The tool 1 and the tool holder 2 are coupled by positioning the circular side portion 6 of the cavity 5 of the tool 1 so as to be concentric with the semicircular recess 16 of the tool holder 2. In particular, the centre C of the circular side portion 6 of the cavity 5 is placed so as to correspond to the centre C′ of the semicircular recess 16 of the tool holder 2 (FIG. 3).

In this configuration, the apex portion 12 of the protrusion 17 of the tool holder 2, partially penetrates into the cavity 5 of the tool 1.

The tool 1 is rotated around the centre C in the direction shown by the arrows in the FIGS. 3 to 6 (clockwise direction). In particular, the surface of the circular side portion 6 is let slide along the surface of the recess 16 so as to rotate the tool 1 around the centre C which coincides with the centre C′. The rotation around the centre C allows the coupling between the tool 1 and the tool holder 2.

In particular, as shown in FIGS. 4 and 5, the rotation of the tool 1 around the centre C allows the apex portion 12 of the protrusion 17 of the tool holder 2 to further penetrate into the cavity 5 of the tool 1. At the same time, as shown in FIG. 5, the apex portion 11 of the protrusion 10 of the tool 1, penetrates into the recess 13 of the tool holder 2.

The completed assembly configuration is shown in FIG. 6. In this configuration, the apex portion 12 of the protrusion 17 of the tool holder 2 abuts the bottom surface 8 of the cavity 5 of the tool 1. At the same time, the apex portion 11 of the protrusion 10 abuts the bottom surface of the recess 13 of the tool holder 2. Moreover, in this configuration, the side portion 7 of the cavity 5 fits together with the curved side surface 9 of the protrusion 17 of the tool holder 2. Furthermore, in this configuration, the upper surface S3 of the tool 1 forms a sort of extension of the main external curved surface 14 of the tool holder 2.

The system is accordingly compact and the wearing of the external surfaces is minimized since they are integrated according to a circular geometry.

Moreover, the coupling between the tool 1 and the tool holder 2 is stable and safe because of the mutual penetration of the protrusion 10 of the tool 1 into the recess 13 of the tool holder 2 and of the protrusion 17 of the tool holder 2 into the cavity 5 of the tool 1.

Furthermore, the assembly process is simple as it is performed by means of the rotation around the common centers C and C′ of the tool 1.

Similarly, in order to remove the tool 1 from the tool holder 2, the tool 1 is rotated in the opposite direction with respect to the direction of the arrows shown in FIGS. 3 to 6 around the common centers C and C′. Accordingly, the disassembly process is simple as well.

As shown in the FIGS. 1 and 1 bis, the tool 1 further comprises a through hole 3 extending along the entire thickness of the tool 1. In other words, the through hole 3 extends perpendicularly to the cross-sections shown in FIGS. 1 and 1 bis. The through hole 3 is located in correspondence to entrance of the cavity 5 of the tool 1.

As shown in the FIGS. 2 and 2bis, the tool holder further comprises a through hole 3′ extending along the entire thickness of the tool holder 2. In other words, the through hole 3′ extends perpendicularly to the cross-sections shown in FIGS. 2 and 2bis. The through hole 3′ is located in correspondence to the base of the protrusion 17 of the tool holder 2. In particular, the through hole 3′ is located in a position of the protrusion 17 such that when the tool 1 is assembled on the tool holder 2 (FIG. 6) the through holes 3 and 3′ are aligned so as to form a single through hole.

This aspect can also be seen in the cross sections shown in FIGS. 8 and 10.

A safety element 4 such as a safety pin or the like is inserted into the through hole formed by the aligned through holes 3 and 3′ so as to safely secure the tool 1 to the tool holder 2.

FIGS. 7 and 9 schematically display a side view of the system in the assembled configuration. As can be seen in the figures and in the corresponding cross sections (FIGS. 8 and 10), a safety element 4 is inserted into the through holes 3 and 3′.

For operating, i.e. for crushing the material to be crushed, the system rotates in the counterclockwise direction as shown by the arrows in FIGS. 7 and 9 so that the frontal crushing surface S4 of the tool 1 impinges upon the material to be crushed.

As can be seen in FIGS. 10 to 13, the tool 1 is provided with wide external surfaces. In particular, the tool 1 comprises a first side surface S1 and a second side surface S2. The side surfaces S1 and S2 are subject to lateral wearing. Moreover, the through hole 3 is drilled through these side surfaces S1 and S2.

The tool 1 further comprises an upper surface S3. The upper surface S3 is curved. In particular, as can be seen for instance in FIGS. 7 and 9, when the tool 1 is assembled on the tool holder 2, the upper surface S3 forms a sort of extension of the main external curved surface 14 of the tool holder 2.

The tool 1 further comprises a frontal crushing surface S4 adapted to impinge on the material to be crushed.

The shape of the external surfaces of the tool is adapted to inhibit and slow down the wearing of the tool itself. Moreover, the shape of the external surfaces is adapted to protect the tool holder from wearing.

For example, as pointed out above with respect to FIG. 2bis, the main external curved surface 14 of the tool holder 2 is such that the cross section of the tool holder 2 in the plane of the figure, i.e. in a plane substantially perpendicular to the rotation axis of the tool holder 2, has substantially the shape of a portion of a spiral. As can be seen in FIGS. 6, 7 and 9, the tool 1 comprises an upper surface S3 which forms substantially an extension of the main external curved surface 14 of the tool holder 2 when the tool 1 and the tool holder 2 are coupled.

It has been shown that in the system according to an embodiment of the present invention, the tool 1 comprises a cavity 5 with a protrusion 6 having circular profile with radius R and centre C adapted to be concentrically coupled with a suitable semicircular recess 16 having the same radius R′ on the tool holder 2, said coupling being stabilized by at least one safety element 4 (such as, for example, a safety pin placed into suitable through holes formed in the tool and in the tool holder).

Moreover, in the system according to a further embodiment of the present invention, the tool 1 comprises two outer side surfaces S1 and S2, an upper surface S3 and a front crushing surface S4, said surfaces S1, S2, S3 and S4 being wide and resistant to the wearing during the crushing processes and adapted to protect the tool holder 2.

Furthermore, in the system according to a further embodiment of the present invention, the coupling between the tool 1 and the tool holder 2 is safely kept in place by means of the geometrical configuration of the inner cavity 5 of the tool 1, said configuration being congruent with the external profile of the tool holder 2, even during the inversion of the working direction of the tool holder 2 without weighing on the safety element 4.

While the invention has been described with respect to the preferred physical embodiments constructed in accordance therewith, it will be apparent to those skilled in the art that various modifications, variations and improvements of the present invention may be made in the light of the above teachings and within the purview of the appended claims without departing from the spirit and intended scope of the invention.

For instance, several kinds of materials can be employed for realizing the tool and the tool holder according to the present invention. Moreover, the tool and the tool holder according to the present invention can have several dimensions. For example, the tool and the tool holder can be adapted to be applied to stationary plants and can have accordingly relatively large dimensions. Alternatively, they can be adapted to be applied to the buckets of movable machines such as buggers or the like and can have accordingly relatively small dimensions.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

1. Coupling system between tool holders and machine tools for crushing machines, wherein the tool comprises:
a cavity with a protrusion having circular profile with radius and centre adapted to be concentrically coupled with a suitable semicircular recess having the same radius on the tool holder, said coupling system being stabilized by at least one safety element and by a tool protrusion penetrating into a tool holder recess, said tool holder recess being opposite to said semicircular recess, and
wherein said tool holder comprises a main external curved surface so that the cross section at mid length of said tool holder in a plane substantially perpendicular to the rotation axis of said tool holder has substantially the shape of a portion of a spiral, and wherein said tool comprises an upper surface, said upper surface of said tool substantially forming an extension of said main external curved surface of said tool holder when said tool and said tool holder are coupled.

2. Coupling system according to claim 1, wherein:
the tool comprises two outer side surfaces, an upper surface and a front crushing surface, said surfaces being wide and resistant to the wearing during the crushing processes and adapted to protect said tool holder.

3. Coupling system according to claim 1, wherein:
the coupling between the tool and the tool holder is safely kept in place by means of the geometrical configuration of the inner cavity of the tool, said configuration being congruent with the external profile of the tool holder, even during the inversion of the working direction of the tool holder without weighing on said safety element.

4. Coupling system according to claim 1, wherein:
said tool protrusion is defined by a second side portion of said cavity, said second side portion being opposite to said protrusion having circular profile, and by an upper outer surface of said tool.

5. Coupling system according claim 1, wherein:
said tool holder comprises a tool holder protrusion, said semicircular recess being at a first side of said tool holder protrusion, said tool holder further comprising a tool holder recess, said tool holder recess being placed at a second side of said tool holder protrusion opposite to said first side, said tool holder recess being adapted to house at least the apex of said tool protrusion.

6. Coupling system according to claim 5, wherein:
said second side of said tool holder protrusion comprises a curved surface, and wherein the side surface of said tool holder recess is formed as an extension of said curved surface.

7. Coupling system according to claim 6, wherein:
said curved surface of said tool holder protrusion is adapted to fit together with a second side portion of said cavity of said tool, said second side portion being opposite to said protrusion having circular profile.

8. Coupling system according to claim 5, wherein:
said tool holder protrusion comprises an apex portion adapted to abut the bottom portion of said cavity of said tool.

9. Coupling system according to claim 1, wherein:
said safety element is placed into a through hole formed by the alignment of a first through hole drilled in the side surfaces of said tool in correspondence to said cavity with a second through hole drilled into said tool holder.

10. (canceled)

11. A coupling structure between a tool holder and a machine tool for use in crushing machines comprising:
a tool holder having a semicircular recess with a first radius adjacent a tool holder apex portion at a first end of a side surface, the side surface having a second end adjacent a recess formed in said tool holder, the side surface forming a protrusion;
a main external curved surface extending adjacent the recess;
a crushing tool having a frontal crushing surface ending in a circular shaped portion having a second radius and an upper curved surface ending in a crushing tool apex portion, the second radius of the crushing tool being equal to the first radius of the tool holder;
a cavity formed in said crushing tool between the second radius and the crushing tool apex portion adapted to receive the protrusion of said tool holder; and
wherein when said tool holder is coupled to said crushing tool, the circular shaped portion of said crushing tool mates with the semicircular recess of said tool holder, the protrusion of said tool holder mates with the cavity of said crushing tool, and the crushing tool apex portion mates with the recess of said tool holder and a spiral is formed from the upper curved surface of said crushing tool and the main external surface of said tool holder,
whereby said tool holder and said machine tool are securely coupled and safely kept in place.

12. A coupling structure between a tool holder and a machine tool for use in crushing machines as in claim 11 further comprising:
a through hole placed through the protrusion and side portions of the cavity.

13. A coupling structure between a tool holder and a machine tool for use in crushing machines as in claim 11 further comprising:
a safety element inserted into said through hole.

14. A coupling structure between a tool holder and a machine tool for use in crushing machines as in claim 11 further comprising:
a main cylindrical opening formed in said tool holder,
whereby a shaft of a crushing machine may be placed.
